(19) United States
(12) Patent Application Publication
(10) Pub. No.: US 2021/0082423 A1
(43) Pub. Date: Mar. 18, 2021

(54) IMAGE CHECKING SYSTEM OF SMART TERMINAL BY USING VOICE DATA AND METHOD THEREOF

(71) Applicant: Hye Sun Song, Seoul (KR)

(72) Inventor: Hye Sun Song, Seoul (KR)

(21) Appl. No.: 16/860,099

(22) Filed: Apr. 28, 2020

(30) Foreign Application Priority Data
Sep. 17, 2019 (KR) 10-2019-0113902

(51) Int. Cl. G10L 15/22; G10L 15/08; G06F 3/16; H04N 5/232

(52) U.S. Cl. CPC G10L 15/22; G10L 15/08; G10L 2015/088; H04N 5/232933; G10L 2015/223; G06F 3/167

(57) ABSTRACT

An image checking system of a terminal using voice data includes: a step where a user provides voice data when shooting image, the voice data are converted into text data, and the text data are matched and saved with image data; a step where a smart terminal is enabled, an image checking app is enabled, and a microphone attached to the smart terminal is operated; a step where data related to image are entered into the microphone using voice; a step where a text conversion module saved on the smart terminal converts the voice data into text data; a step where the text data are transmitted to a control unit of the smart terminal; a step where the control unit checks images that match received text data on image DB saved on a memory unit; and a step where the control unit provides checked image data.

### CROSS REFERENCE TO RELATED APPLICATION

This application claims priority to Korean Patent Application No. 10-2019-0113902, filed Sep. 17, 2019, which is hereby incorporated by reference in its entirety into this application.

### BACKGROUND OF THE INVENTION

### 1. Field of the Invention

The present invention relates to checking and displaying an image saved previously on a smart terminal or PC by using voice data. In general, smart terminal is attached with a camera for smart terminal owner to shoot and save photos of natural landscape and human figure, but it is impossible to find out what images are saved on smart terminal after time passes. User cannot reorganize images or use image data properly.

### 2. Description of Related Art

The related art of this invention is presented in Korean Patent No. 10-1264797 (published on May 15, 2013). FIG. 1 is a flow diagram of the conventional image checking method using face recognition on a portable terminal. In FIG. 1, The conventional image checking method using face recognition on a portable terminal starts (301) from displaying image checking menu as shown by function key (or shortcut key) using key input unit (150) or menu. Once image checking menu requests image check through face recognition, the control unit (125) recognizes this request (303) and determines (305) whether face recognition mode switch function has been set. Also, if face recognition mode switch function is not set, the control unit (125) sets face recognition mode switch function (306). If face recognition mode switch function is set, the control unit (125) proceeds to next step. On one hand, after displaying image checking menu, images can be checked (304) in general mode upon user request. When registering a face for comparison, if there is a need to choose a preregistered face for comparison, the control unit (125) recognizes this need (307) and checks (309) comparison face image folder saved on the memory unit (120). Also, once a face for comparison is selected by the checking, the control unit (125) recognizes this face (311) and switches (313) to face recognition mode. In face recognition mode, the control unit (125) recognizes (315) selected comparison face using the face recognition unit (130). In other words, the control unit (125) uses the face recognition unit (130) to extract partial images that correspond to classifiers useful for recognizing identity of faces from selected comparison face. The control unit (125) compares (317) recognized comparison face with faces included in images of album saved previously on the memory unit (120). Lastly, according to the comparison result, the control unit (125) determines (319) whether an image containing a face that matches comparison face is detected in the album. If an image containing a face that matches recognized comparison face is detected by the determination, the control unit (125) displays (321) detected image using the display unit (145). In other words, the control unit (125) uses the face recognition unit (130) to detect and display images in the album that contain faces with similar images as partial images of recognized comparison face. Here, the control unit (125) may detect one or more images and display detected images as a list. Moreover, the control unit (125) can display images selected by user from displayed list on full screen.

### SUMMARY OF THE INVENTION

The conventional art has a problem of increasing system load because it checks image data based on face recognition. Also, the conventional art comprised as above has a high probability of error because it compares face data. Therefore, the purpose of this invention is to allow for easy checking of image terminal while reducing system load. Another purpose is to reduce the possibility of image checking error.

Image checking system of terminal using voice data and method thereof with the purpose above comprise: A step in which user provides voice data such as John Doe when shooting image, provided voice data are converted into text data, and converted text data are matched and saved with image data; a step in which smart terminal is enabled, image checking app is enabled, and microphone attached to smart terminal is operated; a step in which data related to image to be checked by user are entered into microphone using voice; a step in which text conversion module saved on smart terminal converts voice data entered by microphone on smart terminal into text data; a step in which converted text data are transmitted to control unit of smart terminal; a step in which control unit of smart terminal checks images that match received text data on image DB saved on memory unit; and a step in which control unit of smart terminal provides checked image data through display unit.

### Advantageous Effects of the Invention

Image checking system of terminal using voice data and method thereof comprised as above have an effect of choosing and finding wanted images among many images saved on smart terminal or PC by using keywords. Also, this invention has an effect of offering convenience to users who cannot use text, such as elders and children, by using voice data. Also, another effect of this invention is to increase utility of image data saved for each category by using voice data.

### BRIEF DESCRIPTION OF THE DRAWINGS

FIG. 1 is a flow diagram of the conventional image checking method using face recognition on a portable terminal.

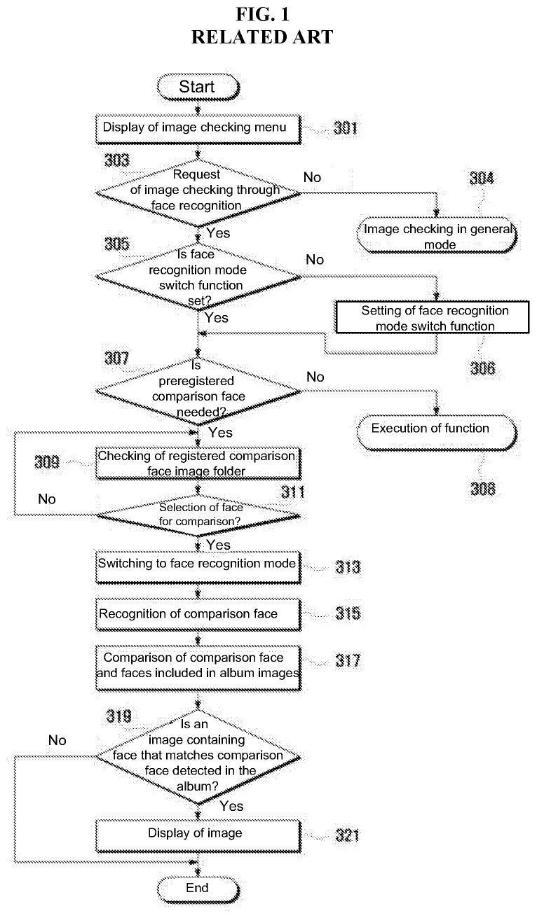

FIG. 2 is a block diagram of image checking system of smart terminal using voice data according to this invention.

FIG. 3 is a detailed block diagram of smart terminal applied to this invention.

FIG. 4 is a control flow diagram of first embodiment of image saving method of smart terminal using voice data applied to this invention.

FIG. 5 is a control flow diagram of second embodiment of image saving method of smart terminal using voice data applied to this invention.

FIG. 6 is a control flow diagram of first embodiment of image checking method of smart terminal using voice data according to this invention.

FIG. 7 is a control flow diagram of second embodiment of image checking method of smart terminal using voice data according to this invention.

### DETAILED DESCRIPTION OF THE INVENTION

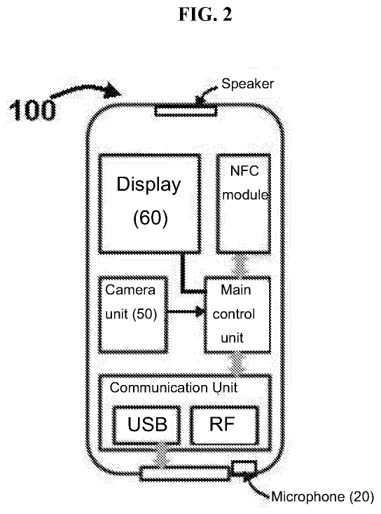

Image checking system of terminal using voice data and method thereof with the purpose above can be explained based on FIG. 2 through 7 as below.

FIG. 2 is a block diagram of image checking system of smart terminal using voice data according to this invention. In FIG. 2, image checking system of smart terminal using voice data according to this invention comprises smart terminal (100) that is enabled by entering password, operates attached microphone (20) by enabling image checking app module (10), converts voice data entered by user using microphone for category to be checked into text data, checks DB (30) based on converted text data, and extracts and displays image data matching converted text data through display unit (60).

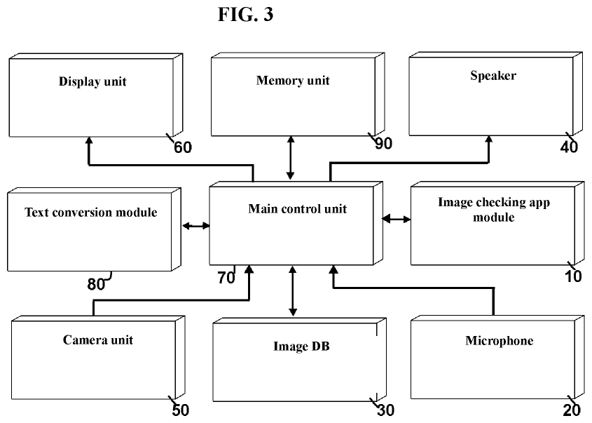

FIG. 3 is a detailed block diagram of smart terminal applied to this invention. In FIG. 3, smart terminal (100) applied to this invention comprises: Camera unit (50) that takes images and transmits image data to main control unit (70); image checking app module (10) that is enabled by user and operates microphone; microphone (20) that is operated by receiving control signals when image checking app module is enabled, receives voice data of user, converts received voice data into electric signals, and transmits converted electric signals to text conversion module; speaker (40) that provides text data (text data for password setting) saved on memory unit as voice data as controlled by main control unit; text conversion module (80) that converts electric signals received from microphone into text data; image DB (30) that saves image data by each category; main control unit (70) that receives image data from camera unit (50) and matches image data with check keyword (or check keyword and password) to be saved on DB, receives password data of user and enables smart terminal, receives voice data of user by enabling image checking app module provided on display unit (60) using click signal of user and transmits control signals to microphone (20) to operate microphone and receive voice data of user, controls electric signals corresponding to voice data from microphone to be transmitted to text conversion module (80), checks images matching converted text data on image DB (30) and saves them on memory unit (90), controls display unit (60) to provide checked image data, and converts text data saved on memory unit into voice data to be provided on speaker; memory unit (90) that saves image data matching checked text data; and display unit (60) that displays checked image data.

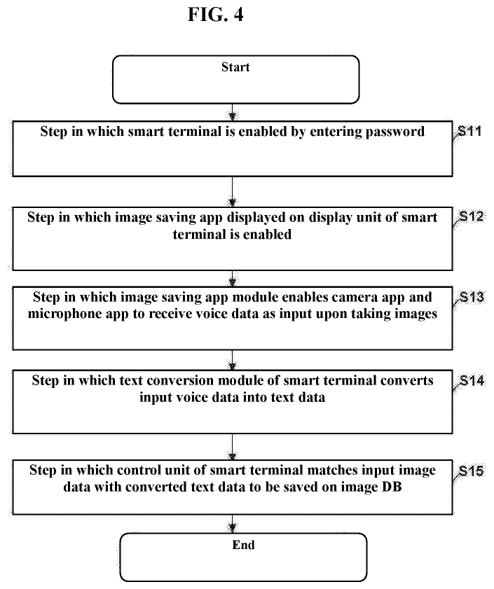

FIG. 4 is a control flow diagram of first embodiment of image saving method of smart terminal using voice data applied to this invention. In FIG. 4, first embodiment of image saving method of smart terminal using voice data applied to this invention comprises: A step (S11) in which smart terminal is enabled by entering password; a step (S12) in which image saving app displayed on display unit of smart terminal is enabled; a step (S13) in which image saving app (module) enables camera app and microphone app to receive voice data as input upon taking images; a step (S14) in which text conversion module of smart terminal converts input voice data into text data; and a step (S15) in which control unit of smart terminal matches input image data with converted text data to be saved on image DB. In the above, image data can be images transmitted by camera and image time data. Also, voice data entered into smart terminal is designated by user and may be name of person whose image is being taken, location of image in case of landscape image, or image time data in case time is important because of birthday.

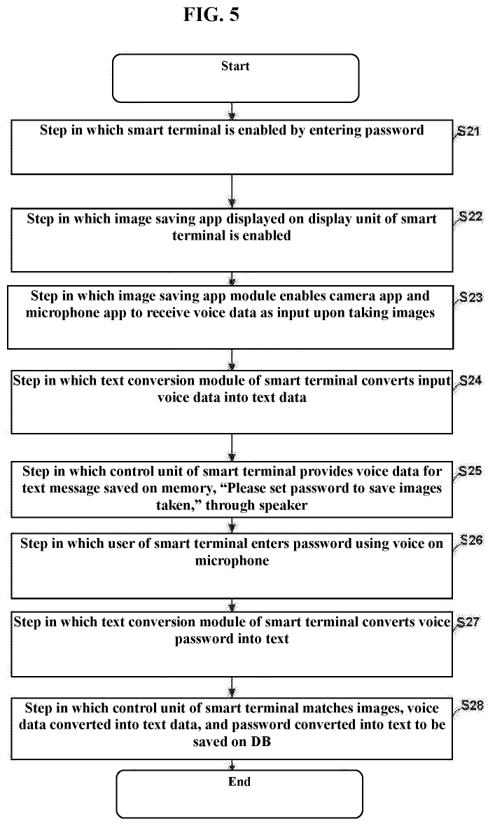

FIG. 5 is a control flow diagram of second embodiment of image saving method of smart terminal using voice data applied to this invention. In FIG. 5, second embodiment of image saving method of smart terminal using voice data applied to this invention comprises: A step (S21) in which smart terminal is enabled by entering password; a step (S22) in which image saving app displayed on display unit of smart terminal is enabled; a step (S23) in which image saving app module enables camera app and microphone app to receive voice data as input upon taking images; a step (S24) in which text conversion module of smart terminal converts input voice data into text data; a step (S25) in which control unit of smart terminal provides voice data for text message saved on memory, “Please set password to save images taken,” through speaker; a step (S26) in which user of smart terminal enters password using voice on microphone; a step (S27) in which text conversion module of smart terminal converts voice password into text; and a step (S28) in which control unit of smart terminal matches images, voice data converted into text data, and password converted into text to be saved on DB. In the above, voice password can exist in various formats including numbers, English alphabets, and Korean letters.

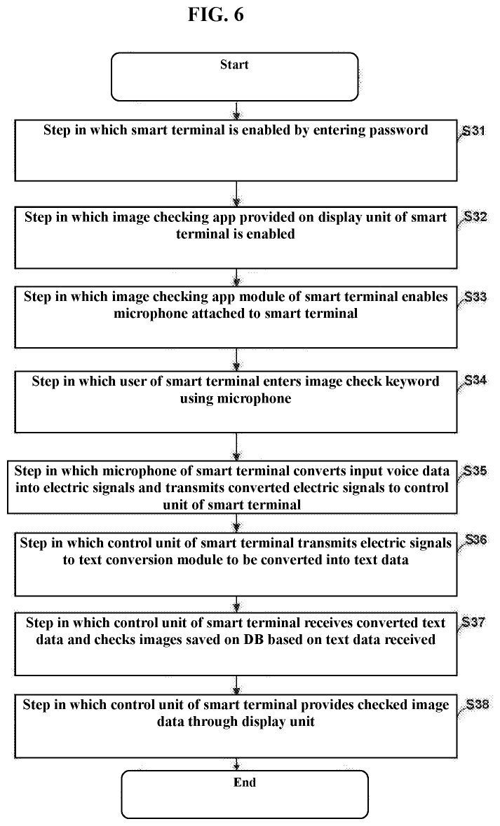

FIG. 6 is a control flow diagram of first embodiment of image checking method of smart terminal using voice data according to this invention. In FIG. 6, first embodiment of image checking method of smart terminal using voice data according to this invention comprises: A step (S31) in which smart terminal is enabled by entering password; a step (S32) in which image checking app provided on display unit of smart terminal is enabled; a step (S33) in which image checking app module of smart terminal enables microphone attached to smart terminal; a step (S34) in which user of smart terminal enters image check keyword using microphone; a step (S35) in which microphone of smart terminal converts input voice data into electric signals and transmits converted electric signals to control unit of smart terminal; a step (S36) in which control unit of smart terminal transmits electric signals to text conversion module to be converted into text data; a step (S37) in which control unit of smart terminal receives converted text data and checks images saved on DB based on text data received; and a step (S38) in which control unit of smart terminal provides checked image data through display unit. If image checking fails in S37, S34 is proceeded after providing checking failure data as voice data using microphone to enter and handle another image check keyword.

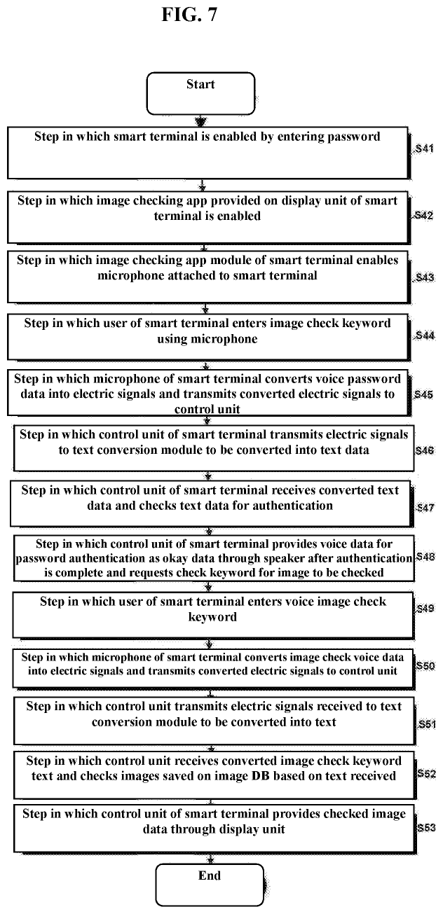

FIG. 7 is a control flow diagram of second embodiment of image checking method of smart terminal using voice data according to this invention. In FIG. 7, second embodiment of image checking method of smart terminal using voice data according to this invention comprises: A step (S41) in which smart terminal is enabled by entering password; a step (S42) in which image checking app provided on display unit of smart terminal is enabled; a step (S43) in which image checking app module of smart terminal enables microphone attached to smart terminal; a step (S44) in which user of smart terminal enters image check keyword using microphone; a step (S45) in which microphone of smart terminal converts voice password data into electric signals and transmits converted electric signals to control unit; a step (S46) in which control unit of smart terminal transmits electric signals to text conversion module to be converted into text data; a step (S47) in which control unit of smart terminal receives converted text data and checks text data for authentication; a step (S48) in which control unit of smart terminal provides voice data for password authentication as “Okay data” through speaker after authentication is complete and requests check keyword for image to be checked; a step (S49) in which user of smart terminal enters voice image check keyword into microphone; a step (S50) in which microphone of smart terminal converts image check voice data into electric signals and transmits converted electric signals to control unit; a step (S51) in which control unit transmits electric signals received to text conversion module to be converted into image check keyword text; a step (S52) in which control unit receives converted image check keyword text and checks images saved on image DB based on image check keyword text received; and a step (S53) in which control unit of smart terminal provides checked image data through display unit. In S47, checking ends if authentication fails. Also, if image checking fails in S52, failure data are provided as voice data through microphone and the step can return to S48.

What is claimed is:

1. A method of checking image data taken and saved with a camera unit attached to a smart terminal using voice data, the method comprising:
a step (S31) in which the smart terminal is enabled by entering a password;
a step (S32) in which an image checking app module provided on a display unit of the smart terminal is enabled by click signals;
a step (S33) in which the image checking app module of the smart terminal enables a microphone attached to the smart terminal;
a step (S34) in which a user of the smart terminal enters an image check keyword using the microphone;
a step (S35) in which the microphone of the smart terminal converts input voice data into electric signals and transmits the converted electric signals to a control unit of the smart terminal;
a step (S36) in which the control unit of the smart terminal transmits electric signals to a text conversion module to be converted into an image check keyword text;
a step (S37) in which the control unit of the smart terminal receives the converted image check keyword text, checks images saved by category on an image DB by matching with check keyword, and saves images on a memory unit;
and a step (S38) in which the control unit of the smart terminal provides the checked image data through the display unit.

2. The method of claim 1, wherein the smart terminal provides check failure data as voice data through the microphone if image checking fails in S37 and another image check keyword is entered and handled by returning to S34.

3. The method of claim 1, wherein the smart terminal comprises:
camera unit (50) that takes images and transmits image data to main control unit (70);
image checking app module (10) that is enabled by user and operates microphone;
microphone (20) that is operated by receiving control signals when image checking app module is enabled, receives voice data of user, converts received voice data into electric signals, and transmits converted electric signals to text conversion module;
speaker (40) that provides text data saved on memory unit as voice data as controlled by main control unit;
text conversion module (80) that converts electric signals received from microphone into text data;
image DB (30) that saves image data by each category;
main control unit (70) that receives image data from camera unit (50) and matches image data with check keyword to be saved on DB, receives password data of user and enables smart terminal, receives voice data of user by enabling image checking app module provided on display unit (60) using click signal of user and transmits control signals to microphone (20) to operate microphone and receive voice data of user, controls electric signals corresponding to voice data from microphone to be transmitted to text conversion module (80), checks images matching converted text data on image DB (30) and saves them on memory unit (90), and controls display unit (60) to provide checked image data;
memory unit (90) that saves image data matching checked text data; and
display unit (60) that displays checked image data.

4. The method of claim 2, wherein the smart terminal comprises:
camera unit (50) that takes images and transmits image data to main control unit (70);
image checking app module (10) that is enabled by user and operates microphone;
microphone (20) that is operated by receiving control signals when image checking app module is enabled, receives voice data of user, converts received voice data into electric signals, and transmits converted electric signals to text conversion module;
speaker (40) that provides text data saved on memory unit as voice data as controlled by main control unit;
text conversion module (80) that converts electric signals received from microphone into text data;
image DB (30) that saves image data by each category;
main control unit (70) that receives image data from camera unit (50) and matches image data with check keyword to be saved on DB, receives password data of user and enables smart terminal, receives voice data of user by enabling image checking app module provided on display unit (60) using click signal of user and transmits control signals to microphone (20) to operate microphone and receive voice data of user, controls electric signals corresponding to voice data from microphone to be transmitted to text conversion module (80), checks images matching converted text data on image DB (30) and saves them on memory unit (90), and controls display unit (60) to provide checked image data;
memory unit (90) that saves image data matching checked text data; and
display unit (60) that displays checked image data.

5. A method of checking image data taken and saved with a camera unit attached to a smart terminal using voice data, the method comprising:
a step (S41) in which the smart terminal is enabled by entering a password;
a step (S42) in which an image checking app module provided on a display unit of the smart terminal is enabled by click signals;
a step (S43) in which the image checking app module of the smart terminal enables a microphone attached to the smart terminal;
a step (S44) in which a user of the smart terminal enters an image check keyword using a microphone;
a step (S45) in which the microphone of the smart terminal converts voice password data into electric signals and transmits the converted electric signals to a control unit;
a step (S46) in which the control unit of the smart terminal transmits electric signals to a text conversion module to be converted into text data;
a step (S47) in which the control unit of the smart terminal receives the converted text data and checks text data for authentication;
a step (S48) in which the control unit of the smart terminal provides voice data for password authentication as “Okay data” through a speaker after the authentication is complete and requests check keyword for image to be checked;
a step (S49) in which the user of the smart terminal enters a voice image check keyword into the microphone;
a step (S50) in which the microphone of the smart terminal converts image check voice data into electric signals and transmits the converted electric signals to the control unit;
a step (S51) in which the control unit transmits electric signals received to the text conversion module to be converted into image check keyword text;
a step (S52) in which the control unit of the smart terminal receives the converted image check keyword text, checks images saved by category on an image DB by matching with check keyword, and saves images on a memory unit; and
a step (S53) in which the control unit of the smart terminal provides checked image data through the display unit.

6. The method of claim 5, wherein the control unit of the smart terminal ends if authentication fails in S47.

7. The method of claim 5, wherein the smart terminal comprises:
camera unit (50) that takes images and transmits image data to main control unit (70);
image checking app module (10) that is enabled by user and operates microphone;
microphone (20) that is operated by receiving control signals when image checking app module is enabled, receives voice data of user, converts received voice data into electric signals, and transmits converted electric signals to text conversion module;
speaker (40) that provides text data (text data for password setting) saved on memory unit as voice data as controlled by main control unit;
text conversion module (80) that converts electric signals received from microphone into text data;
image DB (30) that saves image data by each category;
main control unit (70) that receives image data from camera unit (50) and matches image data with check keyword (or check keyword and password) to be saved on DB, receives password data of user and enables smart terminal, receives voice data of user by enabling image checking app module provided on display unit (60) using click signal of user and transmits control signals to microphone (20) to operate microphone and receive voice data of user, controls electric signals corresponding to voice data from microphone to be transmitted to text conversion module (80), checks images matching converted text data on image DB (30) and saves them on memory unit (90), controls display unit (60) to provide checked image data, and converts text data saved on memory unit into voice data to be provided on speaker;
memory unit (90) that saves image data matching checked text data; and
display unit (60) that displays checked image data.

8. The method of claim 6, wherein the smart terminal comprises:
camera unit (50) that takes images and transmits image data to main control unit (70);
image checking app module (10) that is enabled by user and operates microphone;
microphone (20) that is operated by receiving control signals when image checking app module is enabled, receives voice data of user, converts received voice data into electric signals, and transmits converted electric signals to text conversion module;
speaker (40) that provides text data (text data for password setting) saved on memory unit as voice data as controlled by main control unit;
text conversion module (80) that converts electric signals received from microphone into text data;
image DB (30) that saves image data by each category;
main control unit (70) that receives image data from camera unit (50) and matches image data with check keyword (or check keyword and password) to be saved on DB, receives password data of user and enables smart terminal, receives voice data of user by enabling image checking app module provided on display unit (60) using click signal of user and transmits control signals to microphone (20) to operate microphone and receive voice data of user, controls electric signals corresponding to voice data from microphone to be transmitted to text conversion module (80), checks images matching converted text data on image DB (30) and saves them on memory unit (90), controls display unit (60) to provide checked image data, and converts text data saved on memory unit into voice data to be provided on speaker;
memory unit (90) that saves image data matching checked text data; and
display unit (60) that displays checked image data.
